(19) United States
(12) Patent Application Publication
(10) Pub. No.: US 2007/0099578 A1
(43) Pub. Date: May 3, 2007

(54) Pre-coded diversity forward channel transmission system for wireless communications systems supporting multiple MIMO transmission modes

(76) Inventors: Kathryn Adeney, Fitzroy Harbour (CA); Chris Ward, Bishop's Stortford (GB)

Correspondence Address: Lawrence G. Kurland, Esq.;BRYAN CAVE LLP, 1290 Avenue of the Americas, New York, NY, 10104, US

(21) Appl. No.: 11/544,903

(22) Filed: Oct. 5, 2006

(30) Foreign Application Priority Data
Oct. 28, 2005 (CA) 2,525,337

(51) Int. Cl. H04B 7/14; H04B 1/00; H04B 7/00; H04B 1/02

(52) U.S. Cl. 455/69; 455/101; 455/25; 455/63.4

(57) ABSTRACT

A wireless communications system supporting multiple MIMO transmission modes supporting both diversity and directional transmissions under a plurality of different transmission modes comprises a plurality of transmit and receive antenna elements where the transmit antenna elements are arranged to provide polarization diversity. The transmitting station derives actual knowledge of the forward channel by feeding back certain information such as a preferred beam index and a channel quality indicator figure of merit for that beam from the receiving station to the transmitting station along a reverse channel. The receiving station knows the beam weights used by the transmitting station. The transmitting station applies the fed back information to transmit user data intended for the receiving station in the optimal fashion, such as along the preferred beam and at a time when forward channel conditions are satisfactory. The system provides robust single or multiple stream diversity transmission, together with the option of single user or multi-user beamforming to allow on-the-fly trade-offs between coverage gain and capacity in a wireless telecommunications system.

### CROSS-REFERENCE TO RELATED APPLICATIONS

This Application claims priority from Canadian Patent Application No. 2,525,337 filed Oct. 28, 2005

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION (1) Field of the Invention

The present invention relates to multiple input multiple output (MIMO) wireless communication systems. More particularly, the present invention relates to MIMO wireless communication systems with support for both directional transmission and space or polarization diversity at the transmitting station, and feedback from the receiving station to the transmitting station, to increase the coverage and capacity of the MIMO wireless communication system. (2) Description of Related Art including information disclosed under 37 CFR 1.97 and 1.98.

In the field of wireless communications, as consumer usage patterns and multi-media applications evolve, there is a need for wireless communications providers to deploy wireless communications equipment providing improved data throughput or capacity, and coverage.

As is well known in the art of wireless communications, both directional transmission and diversity transmission are important in improving capacity and coverage.

Directional transmission and diversity transmission each provide link-level gains that may be leveraged to enhance coverage and/or capacity in a wireless network, depending on the data transmission strategy employed.

Diversity transmission refers to the use of one or more distinct, or diverse, propagation channels to send information. By exploiting the diverse propagation channels, information is transmitted more rapidly and/or more reliably.

Directional transmission refers to the shaping of a radiation pattern to be stronger in some directions than in others. Beamforming is a particular type of directional transmission in which the radiation pattern forms a beam shape. The beam is characterized by a predominant direction in which the energy is maximum, denoted the beam point direction or beam direction.

When diversity transmission and directional transmission are combined, there are many different ways in which the antenna system can be used to pass data between a base station and one or more user terminals. These different data transmission methods, which are henceforth referred to as transmission modes or simply modes, have different advantages and disadvantages depending on channel conditions and user traffic patterns. It is therefore advantageous for an antenna system to support several transmission modes. It is further advantageous for the network equipment to be able to select between modes according to channel conditions and user traffic patterns.

It is a requirement that both the transmission mode and the directional radiation patterns must be known by both the transmitting station and receiving station. The control of these aspects by the transmitter requires that the transmitter have knowledge of the “forward” channel, which extends from a transmitter to a receiver. This knowledge is not available directly at the transmitter, since the only channel it is able to monitor is the “reverse” channel. In order to enable mode selection and control of directional transmission, and communication of the selected mode and directional pattern, methods of providing the required information from the receiving station to the transmitting station are proposed. For example, some systems assume that the forward and reverse channels are approximately equal and use the reverse channel characteristics to estimate the forward channel characteristics. This assumption is generally not accurate except possibly in a general sense.

To increase the coverage and capacity of wireless communication systems without increasing the amount of wireless equipment required to serve users, multiple input multiple output (MIMO) models have been developed. An example of a MIMO system is disclosed in U.S. Pat. No. 6,870,515 issued to Kitchener et al. Kitchener et al. discloses a MIMO wireless communication system comprising a plurality of transmit and receive antenna elements, where the transmit antenna elements are arranged so as to provide polarization diversity and to avoid spatial diversity. In such a MIMO system, the antenna polarizations at the transmitter are chosen to be orthogonal (i.e., +45° slant or vertical and horizontal pairs) in order to reduce the physical footprint of transmit antenna elements, thereby limiting the coverage and capacity of the system.

Furthermore, polarization diversity is a well known concept, which has been used to increase the coverage and capacity of a wireless communication system, and has been combined with beamforming. The disadvantages of such systems is that they do not include multimodal support or any feedback of the actual forward channel characteristics.

What is therefore needed is a wireless communication system that supports multiple transmission modes exploiting both diversity and directional transmission, and the exchange of the required information between transmitting and receiving stations.

What is further needed is a means for using directional transmission to maximally improve signal to interference ratios (SNIR) on a network-wide basis.

### SUMMARY OF INVENTION

The present invention seeks to provide a wireless communication system that supports both diversity transmission and directional transmission for transmissions from a centralized access point, sometimes known as a base station, to one or more terminal devices, commonly known as user equipment (UE).

The communications link formed when a base station transmits to a UE is referred to as the downlink (DL).

The communications link formed when a UE transmits to a base station is referred to as the uplink (UL). In some wireless communication systems, multiple base stations may be joined to a core network, to create a wireless network.

The present invention may be applied to an isolated link (whether DL, UL or both) or within a wireless network.

The system of the present invention supports both diversity and directional transmissions under a plurality of different transmission modes. Different transmission modes are used because one may be better suited to a certain propagation channel condition. The transmitting station derives actual knowledge of the forward channel by feeding back certain information to the transmitting station. This feedback allows the transmitting station to control its diversity mode and radiation pattern in a manner that is optimized for the current channel conditions. Feedback may also be used to support transmit scheduling and radio link control decisions that are specified for certain wireless communications networks.

The advantage of the present invention is that it provides robust single or multiple stream diversity transmission, together with the option of single user or multi-user beamforming to allow on-the-fly trade-off between coverage gain and capacity in a wireless communication system.

According to a first broad aspect of an embodiment of the present invention, there is disclosed a multiple-input multiple-output (MIMO) wireless communications system comprising a transmitter and a receiver, the transmitter comprising: a plurality of transmit antenna elements having a plurality of diversity characteristics for transmitting user data to the receiver; a directional transmitter for acting on a first set of weight parameters to coherently combine those transmit antenna elements having a first common diversity characteristic into a first set of directional beams having the first diversity characteristic and for acting on a second set of weight parameters to coherently combine those antenna elements having a second common diversity characteristic into a second set of directional beams each having the second diversity characteristic, the first and second sets providing a plurality of independent MIMO channels for transmission of the user data between the transmitter and the receiver; and a pilot generator associated with each transmit antenna element, for introducing a mutually orthogonal pilot symbol into the user data transmitted by its associated transmit antenna element along each beam in the associated set of directional beams; and the receiver comprising: at least one receive antenna element for receiving the first and second sets of directional beams; a memory for storing the first and second sets of weight parameters; a receive processor for determining a preferred beam in the first and second sets of directional beams based on the stored first and second sets of weight parameters; and a reverse channel signaler for communicating to the transmitter the preferred beam; wherein the transmitter may transmit the user data intended for the receiver along the preferred beam to the receiver.

According to a second broad aspect of an embodiment of the present invention, there is disclosed a transmitter for a multiple-input multiple-output (MIMO) wireless communications system comprising: a plurality of transmit antenna elements having a plurality of diversity characteristics for transmitting user data to a receiver; a directional transmitter for acting on a first set of weight parameters to coherently combine those transmit antenna elements having a first common diversity characteristic into a first set of directional beams having the first diversity characteristic and for acting on a second set of weight parameters to coherently combine those antenna elements having a second common diversity characteristic into a second set of directional beams each having the second diversity characteristic, the first and second sets providing a plurality of independent MIMO channels for transmission of the user data between the transmitter and the receiver; and a pilot generator associated with each transmit antenna element, for introducing a mutually orthogonal pilot symbol into the data transmitted by its associated transmit antenna element along each beam in the associated set of directional beams whereby the receiver may determine a preferred beam from the received pilot symbols and communicate it to the transmitter for use with the user data intended for the receiver.

According to a third broad aspect of an embodiment of the present invention, there is disclosed a receiver for a multiple-input multiple-output (MIMO) wireless communications system comprising: at least one receive antenna element for receiving, from a transmitter, a first set and a second set of directional beams containing user data coherently combined using sets of weight parameters, each beam further comprising a series of initially orthogonal pilot symbols associated with each antenna element of the transmitter; a memory for storing the first and second sets of weight parameters; a receiver processor for determining a preferred beam in the first and second sets of directional beams based on the stored first and second sets of weight parameters; and a reverse channel signaler for communicating to the transmitter the preferred beam; whereby the receiver may determine a preferred beam and communicate it to the transmitter wherein the transmitter may transmit the user data intended for the receiver along the preferred beam to the receiver.

According to a fourth broad aspect of an embodiment of the present invention, there is disclosed A method of multiple-input multiple-output (MIMO) wireless communications between a transmitter and a receiver comprising the steps of: the transmitter: acting on a first set of weight parameters to coherently combine transmit antenna elements having a first common diversity characteristic into a first set of directional beams each having the first diversity characteristic; acting on a second set of weight parameters to coherently combine antenna elements having a second common diversity characteristic into a second set of directional beams each having the second diversity characteristic; providing the first and second sets of directional beams as a plurality of independent MIMO channels for transmitting user data between the transmitter and the receiver; and introducing a mutually orthogonal pilot symbol into the user data transmitted by its associated transmit antenna element along each beam in the associated set of directional beams; and the receiver: receiving the first and second sets of directional beams at at least one receive antenna element; storing the first and second sets of weight parameters; determining a preferred beam in the first and second sets of directional beams based on the stored first and second sets of weight parameters; and communicating to the transmitter the preferred beam; wherein the transmitter may transmit the user data intended for the receiver along the preferred beam or beams to the receiver.

### BRIEF DESCRIPTION OF THE SEVERAL VIEWS OF THE DRAWING(S)

The embodiments of the present invention will now be described by reference to the following figures, in which identical reference numerals in different figures indicate identical elements and in which:

FIG. 1 shows the transmitter's pre-coder architecture according to an embodiment of the present invention;

FIG. 2 shows an example of beam patterns resulting from two antenna elements spaced at one half of the signal wavelength according to an embodiment of the present invention;

FIG. 3 shows an example of beam patterns resulting from two antenna elements spaced at ten wavelengths, according to an embodiment of the present invention; and

FIG. 4 shows a MIMO channel between the transmitter of the embodiment of FIG. 1 with two receiver antennas according to an embodiment of the present invention.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

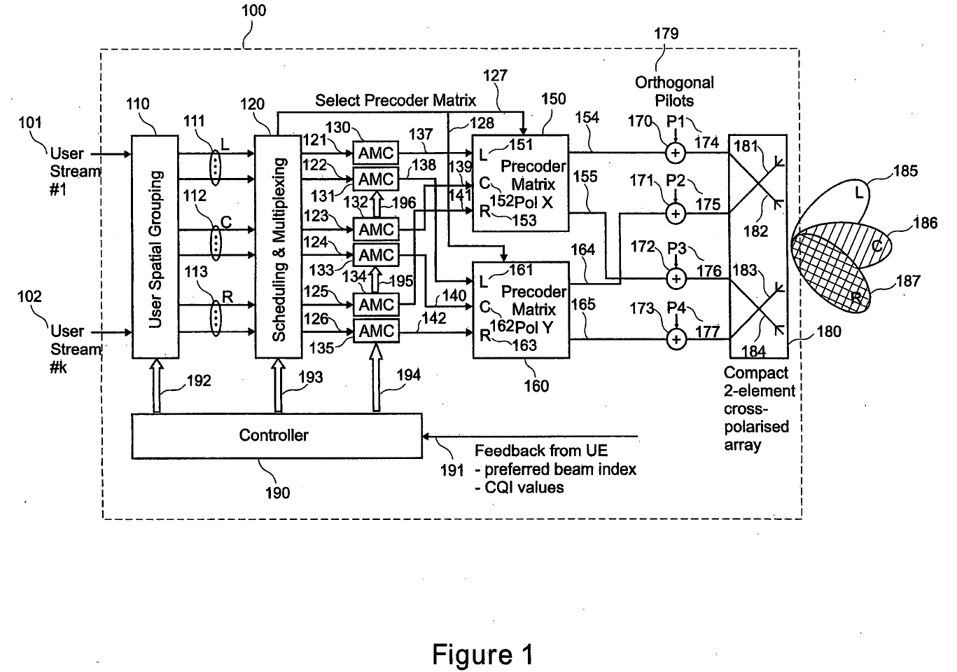

Referring to FIG. 1, there is shown a basic transmitting station pre-coder architecture, shown generally at 100, according to the present invention.

The transmitting station 100 comprises a spatial grouper 110, a scheduler 120, a plurality of adaptive modulation coders (AMCs) 130-135, a plurality of linear transformers or pre-coder matrices 150, 160, a plurality of pilot tone mixers 170-173, a cross-polarized antenna array 180 and a controller 190.

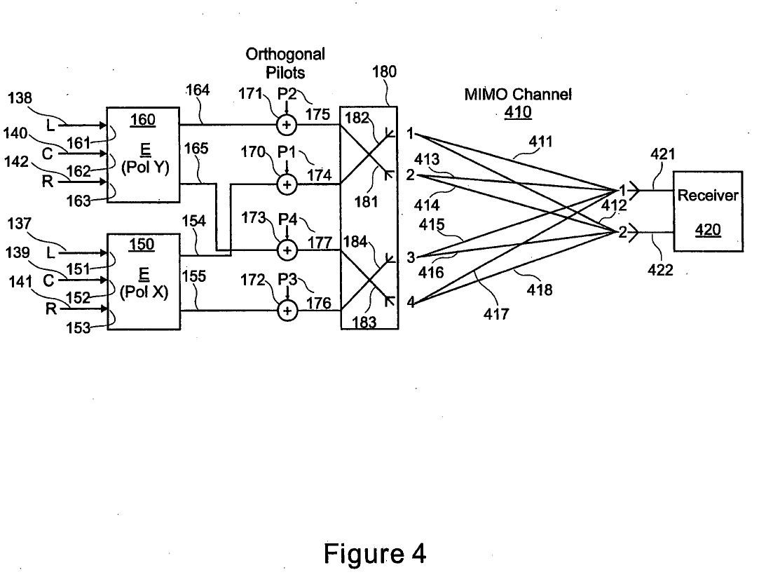

The transmitting station 100 accepts as input a plurality of user streams 101-102 of data to be transmitted along the forward channel and a feedback signal from one or more receiving stations along the reverse channel and outputs a plurality of shaped beams of energy 185-187 containing the data for receipt by one or more of the receiving stations 420 (FIG. 4).

The spatial grouper 110 accepts as input each of the plurality of user streams 101-102 and a feedback grouping control signal 192. It allocates the data to be transmitted along a plurality of beam streams 111-113 to the scheduler 120. The beam streams 111-113 correspond respectively to the shaped energy beams 185-187 output by the pre-coder 100 along the forward channel. In the exemplary embodiment discussed herein, where there are three shaped energy beams 185-187, designated Left (L) 185, Centre (C) 186 and Right (R) 187 respectively, there would be three corresponding beam streams of user data, respectively 111, 112 and 113.

While conceptually, as shown in FIG. 1, each user data stream 101-102 may be allocated to each of the beam streams 111-113, typically, at any given point in time, a user data stream will be allocated to only a single beam stream 111-113. However, changes in the operating environment, including the transmitting channel characteristics and the user traffic pattern, may mandate a change at a later period in time between a first beam stream and a second beam stream, as discussed below. Such a change may be initiated by the spatial grouper 110 in response to the feedback grouping control signal 192 received from the controller 190. This feedback grouping control signal 192 is derived from, inter alia, the index of a preferred beam corresponding to a particular receiving station and the channel quality indicator (CQI) associated with the preferred beam. For example, if the controller 190 determines that a particular UEᵢ has indicated a preference for the Right (R) beam for its user data as described below, and that data from user stream j is intended for UEᵢ, the controller 190 instructs the spatial group 110 to group user stream j into the Right (R) beam stream 113.

The scheduler 120 accepts as input each of the beam streams 111-113 and a feedback scheduler control signal 193 and generates a plurality of scheduled data streams 121-126 and a plurality of precoder selection control signals 127-128. In the simple 2-element 3-beam example shown in FIG. 1, the precoder selection control signals 127-128 may not be required. In a more complex arrangement involving a larger number of elements and a greater number of beams, it may be more appropriate to partition the architecture using a number of selections to precoder matrices. In such a case, different precoder matrices can be used on the different antenna polarizations.

The scheduler 120 orders the data that arrives along the beam streams 111-113 and generates a scheduled data stream for processing by a corresponding AMC 130-135. The ordering established may change in response to changes in the operating environment, including the transmitting channel characteristics and the user data traffic environment. For example, if there is not a favourable channel available for transmission, the scheduler 120 may inhibit data transmission until conditions improve sufficiently. Such a change may be initiated by the scheduler 120 in response to the feedback scheduler control signal 193 received from the controller 190. This feedback scheduler control signal 193 is derived from, inter alia, a channel quality indicator (CQI) figure of merit.

In addition to ordering the data into a scheduled data stream, the scheduler 120 may implement a multiplexing scheme in order to improve the channel utilization. Those having ordinary skill in this art will readily recognize which multiplexing schemes may be most suitable. The notion of packet wireless access with scheduling is a form of time division multiplexing (TDM) which is already described in the context of the precoder solution. Alternatively, the system may use an orthogonal frequency division multiplexing (OFDM) access technology and different users may be allocated different segments of the available spectrum, that is, a sub-block of the available OFDM sub-carriers. Other potential candidates will readily come to mind to those having ordinary skill in this art.

The number of scheduled data streams 121-126 corresponds to the number of adaptive modulation coders 130-135, which in turn corresponds to the product of A, the number of pre-coder matrices 150, 160 and B, the number of shaped energy beams 185-187. In the exemplary embodiment shown in FIG. 1, there are two pre-coder matrices 150, 160 (A=2) and three shaped energy beams 185, 186, 187 (B=3), so that there are six (A×B=6) AMCs 130-135 and six scheduled streams. 121-126. Each of the scheduled streams 121-126 feed into a corresponding AMC 130-135. The pre-coder selection control signals 127-128 generated by the scheduler 120 control one of the pre-coder matrices.

Each adaptive modulation coder 130-135 accepts as input a corresponding scheduled data stream 121-126 generated by the scheduler 120 and a feedback coder control signal 194-196 (only three such signals are shown for clarity) and generates a corresponding coded data stream 137-142 for input into one of the pre-coder matrices 150, 160.

Each AMC 130-135 modulates and encodes the data in accordance with one of a plurality of known modulation and/or encoding schemes. Those having ordinary skill in this art will readily recognize that the choice of modulation and/or coding scheme may vary according to the transmitting channel characteristics and the user data traffic environment in response to the feedback coder control signals 194-196 received from the controller 190. These feedback coder control signals 194-196 are derived from, inter alia, one or more channel quality index (CQI) figures of merit.

As indicated, the number of AMCs 130-135 corresponds to the product of A, the number of pre-coder matrices 150, 160 and B, the number of shaped energy beams 185-187.

Thus, of the A×B (=6 in the illustrative embodiment of FIG. 1) coded data streams, B (=3 in the illustrative embodiment of FIG. 1) coded data streams 137-142, corresponding to each of the B shaped energy beams 185-187 will be allocated to each of the A (=2 in the illustrative embodiment of FIG. 1) pre-coder matrices 150, 160. For example, coded data streams 137, 139, 141 are generated for processing by pre-coder matrix 150 and coded data streams 138, 140, 142 are generated for processing by pre-coder matrix 160.

Diversity is achieved through a plurality of polarizations. Each polarization implements a separate diversity branch. A, the number of pre-coder matrices 150, 160, also denotes the number of diversity branches.

The pre-coder matrices, designated X 150 and Y 160, respectively, are used on the two diversity branches.

The pre-coders 150, 160 provide complex weightings of the antenna inputs arriving at inputs 151-153, 161-163 corresponding to the Left, Centre and Right beams respectively that shape the radiation pattern, which in turn control directional transmission. The pre-coders 150, 160 may not necessarily be identical. They may be different if the antenna element patterns are different for the two polarizations. For simplicity, in the illustrated embodiments, identical element patterns are assumed for the two polarizations so the pre-coders 150, 160 are identical. Each pre-coder matrix 150, 160 generates a plurality of beams (in the illustrated embodiment of FIG. 1 there are three beams) of encoded data 154, 155, 164, 165, labeled as the Left (L), Centre (C) and Right (R) beams. A person of ordinary skill in the art will readily recognize that the beamweight parameters submitted to each pre-coder may be different, and that, subject to some limitations, any number of beams may be constructed. The beams are constructed to provide good, unambiguous coverage across the sector with minimum beamwidth designs consistent with the dimension of the available antenna array 180 dimensions. If the antenna array 180 comprises more than two antennas, more and more complex beam patterns may be possible with the provision of suitable beamweight parameters.

Independent (orthogonal) pilots 174-177 are applied to the individual antennas at the transmitting station through a plurality of mixers 170-173. In multi-user wireless networks, these pilot transmissions are used by a receiving station 420 to determine a preferred serving cell (not shown). The pilot signal transmissions also enable the receiving station 420 to make channel quality indicator (CQI) measurements, select the best beam or beams within the serving cell, and perform MIMO transmission modes, as discussed below. Pilot transmissions, unlike data transmissions, do not undergo the pre-coding operation.

The transmitting station is equipped with a plurality of groups of antenna elements [181, 183], [182, 184] with one group being used for each diversity branch. In the illustrative embodiment of FIG. 1, group [181, 183] corresponds to pre-coder matrix Y 160 (for diversity branch Y), while group [182, 184] corresponds to pre-coder matrix X 150 (for diversity branch X). The preferred configuration is to have sub-wavelength spacing of the array elements within each diversity branch. However, the same approach is applicable to arrays with wider spacing, in which case spatial diversity may be employed in addition or in substitution for polarization diversity. For illustration, FIG. 1 shows a dual column cross-polar antenna array 180, however a person of ordinary skill in the relevant art will readily recognize that the discussion presented here may be generalized to larger array sizes and arbitrary array geometries.

The controller 190 accepts the feedback signal 191 from one or more receiving stations 420 along a reverse channel (not shown) and generates the feedback grouping control signal 192, the feedback scheduler control signal 193 and a plurality of feedback coder control signals 194-196 that are fed to the spatial grouper 110, scheduler 120 and adaptive modulation coders (AMCs) 130-135 respectively.

The feedback signal 191 comprises a preferred beam index from the responding receiving station 420 that is indicative of the receiving station 420's preference, based upon the existing conditions along the forward channel 410 between the transmitting station 100 and the receiving station 420, of along which beam, user data intended for it should be transmitted.

Preferably, the feedback signal 191 also comprises a channel quality indicator (CQI) figure of merit corresponding at least to the designated preferred beam.

In operation, user data streams 101-102 are grouped by the spatial grouper into an appropriate beam stream 111-113, corresponding to a preferred beam index designated by the intended recipient receiving station 420 and fed back to the transmitting station 100 in the feedback signal 191 along the reverse channel (not shown) extending between the transmitting station 100 and the receiving station 420.

Each beam stream 111-113 is scheduled and multiplexed by the scheduler 120, in accordance with the existing conditions of the forward channel 410 extending between the transmitting station 100 and the intended recipient receiving station(s) 420 as denoted by the corresponding CQI figure(s) of merit fed back to the transmitting station 100 in the feedback signal 191 along the reverse channel (not shown) extending between the transmitting station 100 and the receiving station(s) 420.

The scheduler 120 generates a plurality of scheduled streams 121-126 corresponding to a unique pair of the A diversity branches and B beams in the transmitter station 100 and feeds each scheduled stream 121-126 into a corresponding AMC 130-135.

Each AMC 130-135 encodes and modulates the corresponding scheduled stream 121-126 in accordance with a modulation and encoding scheme that is appropriate having regard to the existing conditions of the forward channel 410 extending between the transmitting station 400 and the intended recipient receiving station(s) 420 as denoted by the corresponding CQI figure(s) of merit for the associated beam, fed back to the transmitting station 100 in the feedback signal 191 along the reverse channel (not shown) extending between the transmitting station 100 and the receiving station 420.

The AMCs 130-135 corresponding to a particular diversity branch generates a coded data stream 137-142 that is provided to the associated pre-coder matrix 150, 160.

Each pre-coder matrix 150, 160 applies a complex weighting using pre-determined beamforming weights to generate directional beams from the input coded data streams and outputs a plurality of beams of encoded data 154, 155, 164, 165.

The encoded beams of data 154, 155, 164, 165 are each mixed with an orthogonal pilot signal 174-177 by mixers 170-173 respectively and are output to the compact multi-element cross-polarized array 180 along the A diversity branches (in the illustrative embodiment of FIG. 1, A=2).

The orthogonal pilot signals 174-177, which are not beamformed in the present embodiment, may be monitored by the receiving station(s) 420 in order to determine the channel quality indication (CQI) figure(s) of merit and the preferred beam index, which information may be fed back to the transmitting station 100's controller 190 as the feedback signal 191 along the reverse channel (not shown) extending between the receiving station(s) 420 and the transmitting station 100.

In relation to FIG. 1, which shows a two-element array on each diversity branch with each array using an identical three-column (three beam) preceding matrix, the pre-coder transformation may be expressed by:
E=[e_{L}e_{C}e_{R}] (1)
where e_{L}, e_{C} and e_{R} are the fixed beamformer weights needed to form the three beams (denoting Left, Centre and Right pointing directions). Accordingly, the two-element cross-polarized antenna configuration may be expressed as:

$$E = [ \begin{matrix}{e}_{L 1} & {e}_{C 1} & {e}_{R 1} \\ {e}_{L 2} & {e}_{C 2} & {e}_{R 2}\end{matrix} ] \qquad ( 2 )$$

Based on this definition, there is no need for the pre-coder transformation, E to be orthogonal. Preferably, the pre-coder transformation E will be designed so as to make the overall beam envelope match, as closely as possible, the required reference sector coverage pattern and to give each of the resulting beams a similar ground footprint (for example, equal coverage and user traffic loading). The beam shapes may be optimized by adjusting a number of variables, including but not limited to element spacing, element patterns, scan angles of all beams (about boresight) and amplitude weighting of all beams relative to a central beam.

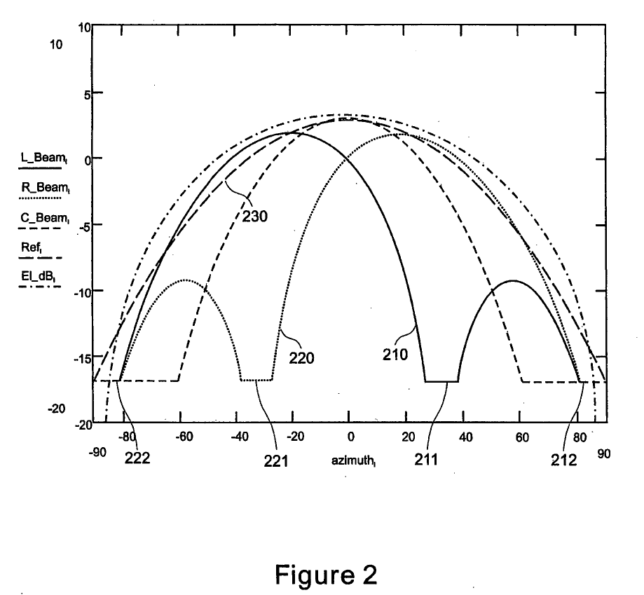

FIG. 2 illustrates an exemplary three-beam pattern shown as dB gain (Y-axis) as a function of beam angle (X-axis), based upon a two-element array with elements spaced at one-half wavelength, such as is shown in the illustrative embodiment of FIG. 1. The element pattern reflects the relation:
G(θ)=cos²θ (3)
where θ is the angle and G(θ) is the gain (linear scale).

Here, left 210 and right 220 beams are steered by −28° and +28° respectively relative to the centre beam 230. The pattern is shown clipped at −20 dB below the peak (211, 212, 221, 222) for formatting reasons. In fact, the realized pattern would not experience such clipping.

Refᵢ is the target sector coverage envelope, that is, the azimuthal response to which the coverage of the multibeam patterns are attempted to be matched. Refᵢ is the standard sector beam pattern specified in the 3GPP/PP2 standards and is universally adopted for performance simulations.

Eᵢ is the azimuthal pattern of the assumed element response, that is, for a single element of the two-element antenna array 180. It is assumed that Eᵢ is the same on both polarizations.

The corresponding weighting matrix is:

$$\begin{matrix}E = [ \begin{matrix}{e}_{L 1} & {e}_{C 1} & {e}_{R 1} \\ {e}_{L 2} & {e}_{C 2} & {e}_{R 2}\end{matrix} ] \\ = [ \begin{matrix}0.500 - j 0.448 & 0.707 & 0.500 - j 0.448 \\ 0.55 + j 0.448 & 0.707 & 0.500 - j 0.448\end{matrix} ]\end{matrix} \qquad ( 4 )$$

For the case of widely spaced array elements, for example, where spatial diversity is used instead of or in addition to polarization diversity, the same parameters may be adjusted to achieve different design objectives. For example, the element spacing may be chosen so that the lobe width is smaller than the per-mobile multipath angle scatter, the scan angles of the first lobes of the left (L) and right (R) beams may be adjusted so that the grating lobes of all three beams are evenly spaced and uniformly cover the field of coverage, and the element pattern may be designed so that the beam envelope is a reasonably close match to the required reference sector coverage patterns.

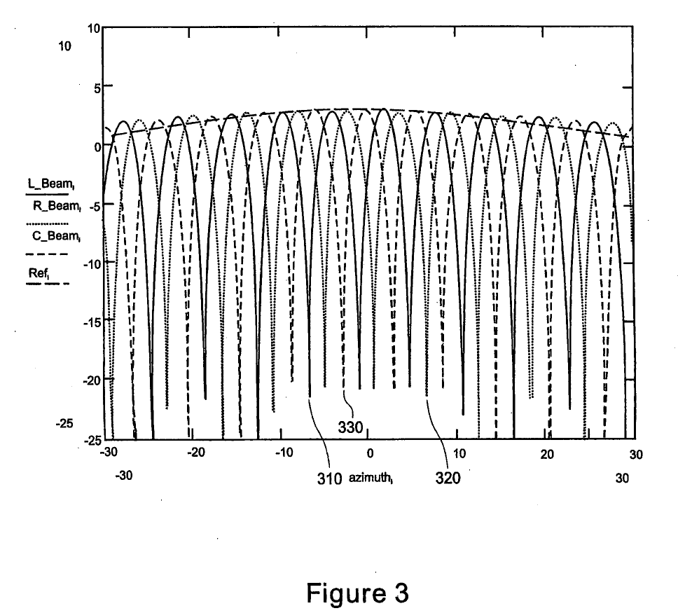

FIG. 3 shows an exemplary three-beam pattern, again shown as dB gain (Y-axis) as a function of angle (X-axis), based on a two-element array with elements spaced at ten wavelengths. The element pattern again reflects the relation shown in equation (3). Here, however, the left 310 and right 320 beams are steered by −2° and +2° respectively relative to the centre beam 330 and the corresponding weight matrix is given by:

$$\begin{matrix}E = [ \begin{matrix}{e}_{L 1} & {e}_{C 1} & {e}_{R 1} \\ {e}_{L 2} & {e}_{C 2} & {e}_{R 2}\end{matrix} ] \\ = [ \begin{matrix}0.323 - j 0.629 & 0.707 & 0.323 - j 0.629 \\ 0.323 + j 0.629 & 0.707 & 0.323 - j 0.629\end{matrix} ]\end{matrix} \qquad ( 5 )$$

The pre-coder transformation, E needs to be known at the receiving station 420 as well as at the transmitting station 100. Ideally, the pre-coder dictionary should be configurable to the receiving station 420 to accommodate different pre-coder designs optimized according to deployment or network. This configuration may be done by signaling between the transmitting station 100 and the receiving station 420. In the case of a pre-coder matrix used by the base station for downlink transmissions, this may be communicated to the UE, either once on initialization for fixed pre-coding arrays, or more often in a system supporting dynamic or variable pre-coding arrays. In a cellular network, it may be desirable for different base stations to use different pre-coder arrays; in this case pre-coder matrices would need to be signaled to the UE at handover.

The transmitting station 100 may also adaptively tune or learn its pre-coder matrix such that the matrix is tailored to the forward channel 410 conditions and spatial traffic distribution in the area affecting signal quality at that transmitting station 100. This is done by measuring the reverse channel (not shown) transmissions over a fairly long period of time. This adaptive pre-coder matrix tuning makes us of a capability to signal new pre-coder matrices to the receiving station. Control signals 197 and 198 extend from the controller 190 to the precoder matrices 150, 160 to allow the precoder coefficients to be updated.

In the two-element cross-polarization antenna shown in FIG. 1, the pre-coder beam patterns are constructed so that the central beam provides coverage in-fill around the cusp region of the left and right beams. This ensures that the best beam selection produces negligible cusping loss. A person of ordinary skill in the relevant art will readily recognize that larger array sizes, such as those with 4, 6 or 8 spatial elements, may be used for significantly improved performance of the system. However, these configurations will use an increased number of orthogonal pilots for the forward channel 410 transmission, with corresponding increased feedback for best beam indication, and involve a physically larger antenna structure.

Numerous modes, or methods of transmitting data over the diversity branches and beams, are possible. Depending on the mode of transmission, the receiving station 420 can have one, two or more signal paths, commonly known as receive diversity branches. Each receive data path may originate from an individual antenna, or a group of closely spaced antennas having like polarizations (cf. eg. 421, 422). FIG. 4 shows a representation for the MIMO forward channel 410 for the two-column cross-polarized array 180 discussed in FIG. 1 assuming two receiver antennas 421, 422. Based on the representation shown in FIG. 4, the channel matrix may be defined as follows:

$$H = [ \begin{matrix}{h}_{11} & {h}_{12} \\ {h}_{21} & {h}_{22} \\ {h}_{31} & {h}_{32} \\ {h}_{41} & {h}_{42}\end{matrix} ] \qquad ( 6 )$$

where h₁₁ represents the channel defined by the path 411 between transmitter antenna 1 182 and receiver antenna 1 421;
h₂₁ represents the channel defined by the path 413 between transmitter antenna 2 181 and receiver antenna 1 421;
h₃₁ represents the channel defined by the path 415 between transmitter antenna 3 184 and receiver antenna 1 421;
h₄₁ represents the channel defined by the path 417 between transmitter antenna 4 183 and receiver antenna 1 421;
h₁₂ represents the channel defined by the path 412 between transmitter antenna 1 182 and receiver antenna 2 422;
h₂₂ represents the channel defined by the path 414 between transmitter antenna 2 181 and receiver antenna 2 422;
h₃₂ represents the channel defined by the path 416 between transmitter antenna 3 184 and receiver antenna 2 422; and
h₄₂ represents the channel defined by the path 418 between transmitter antenna 4 183 and receiver antenna 2 422.

In operation, the UEs determine an estimate of the forward MIMO channel 410 described by H by detecting the received amplitudes and phases of the four orthogonal pilots, P1 174, P2 175, P3 176 and P4 177 transmitted from the transmitting station 100. The H matrix may be partitioned into two sub-matrices which describe the propagation paths between the transmitter and the receiving station 420 using polarization X at the transmitting station 100:

$${H}_{X} = [ \begin{matrix}{h}_{11} & {h}_{12} \\ {h}_{31} & {h}_{32}\end{matrix} ] \qquad ( 7 )$$

and the propagation paths between the transmitting station 100 and the receiving station 420 using polarization Y at the transmitting station 100:

$${H}_{Y} = [ \begin{matrix}{h}_{21} & {h}_{22} \\ {h}_{41} & {h}_{42}\end{matrix} ] \qquad ( 8 )$$

The vector e_{S} represents the pre-coding transformation corresponding to the selected beam which will be applied to the data transmissions from the transmitting station 100 on both diversity branches. The equivalent MIMO channel matrix, including the effect of the pre-coding transformation, is given by:

$$\begin{matrix}G = [ \begin{matrix}{g}_{11} & {g}_{12} \\ {g}_{21} & {g}_{g 22}\end{matrix} ] \\ = [ \begin{matrix}( {e}_{S 1} {h}_{11} + {e}_{S 2} {h}_{31} ) & ( {e}_{S 1} {h}_{12} + {e}_{S 2} {h}_{32} ) \\ ( {e}_{S 1} {h}_{21} + {e}_{S 2} {h}_{41} ) & ( {e}_{S 1} {h}_{22} + {e}_{S 2} {h}_{42} )\end{matrix} ]\end{matrix} \qquad ( 9 )$$

where S is the index of the selected beam (i.e., S is either .L, C or R).

Here, gᵢⱼ is the channel between transmit diversity branch i and receive branch j. The matrix G is used in the UE receiver to recover data intended for it, from the total signal impinging upon it.

Now let:

$$\begin{matrix}X = [ \begin{matrix}{x}_{L 1} & {x}_{L 2} \\ {x}_{C 1} & {x}_{C 2} \\ {x}_{R 1} & {x}_{R 2}\end{matrix} ] = {E}^{T} {H}_{A} \\ and & ( 10 ) \\ Y = [ \begin{matrix}{y}_{L 1} & {y}_{L 2} \\ {y}_{C 1} & {y}_{C 2} \\ {y}_{R 1} & {y}_{R 2}\end{matrix} ] = {E}^{T} {H}_{B} & ( 11 )\end{matrix}$$

These are the combined precoding and channel transformations for all beams of the two transmit diversity branches. The components of matrices X and Y represent the effective complex beam amplitudes received by the two receive branches for each of the two transmitted polarizations. The receiving station 420 may select one beam based on average measurements made over both diversity branches, or may select a different beam for each diversity branch.

The receiving station 420 may select the preferred beam for transmission of data by comparing channel quality or power estimates from each of the three (Left, Center and Right) beams.

For example, if a single beam per user is selected (that is, the same beam is applied on both transmitter polarizations), the receiving station 420 determines the following:
Power_Beam_L=|x_{L1}|²+|x_{L2}|²+|y_{L1}|²+|y_{L2}|² (12)
Power_Beam_C=|x_{C1}|²+|x_{C2}|²+|y_{C1}|²+|y_{C2}|² (13)
Power_Beam_R=|x_{R1}|²+|x_{R2}|²+|y_{R1}|²+|y_{R2}|² (14)

In this particular example, the best beam corresponds to the selection which provides maximum summed received power.

Feedback from Receiving Station to Transmitting Station

Depending on the outcome of the receiving station's beam selection procedure, the receiving station 420 feeds back a preferred beam index or preferred beam indices to the transmitting station 100. This requires the transfer of [log₂C] bits of information per feedback interval on the uplink to indicate the best beam from those available, where C is the number of beams and [x] denotes the smallest integer that is not less than x.

The transmitting station 100 will transmit to the receiving station 420 on the selected beam using one of the transmission modes as discussed below.

Alternatively, the receiving station 420 may feed back the full channel matrix H. Such full channel feedback would allow the transmitting station 100 to select a column from a predetermined pre-coding matrix using the above equation, transferring some complexity from the receiving station 420 to the transmitting station 100. This is desirable for the downlink case, since base station complexity is preferable to UE complexity. Full channel feedback would also allow the transmitting station 100 to instantaneously formulate a pre-coding matrix optimized for the fed back user channel. One cost of this flexibility would be an increased number of feedback bits and the introduction of additional signaling to inform the receiving station 420 of the beam selection decision.

It should be noted that in the above description, a channelization resource refers to the smallest transmission resource that can be assigned to a single user in a multiple access system. Simple examples include a frequency band in an FDMA system or a timeslot in a TDMA system. In a system supporting multiple users through a multiple access scheme with multiple channelization resources, there may be many concurrent users. The single user/multi-user distinction and the descriptions used therein are with respect to one channelization resource, but can then be applied across all available multiple access channels. There are many alternative multiple access technologies. The present invention may be used with any of them.

In the case in which the transmitting station 100 is a base station, in addition to beam selection feedback, the UE (receiving station 420) supplies channel quality indicators (CQI) to the base station. Either a single “joint CQI” describing the average channel quality for both diversity branches on the preferred beam, or else a CQI for each diversity branch, is provided, depending upon the transmission mode. CQI feedback enables scheduling and radio link control features in some wireless networks. Furthermore, as described above, CQI feedback is used within the proposed system to select certain aspects of some of the transmission modes.

MIMO Transmission Modes

Numerous transmission modes are possible using the system of the present invention. The transmission modes may be roughly grouped into those that support a single user per channelization resource, and those that support multiple users on a single channelization resource. In a system supporting multiple channels, there may be many concurrent users. Tables 1 and 2 below describe transmission modes that are supported by a base station using the present invention when each user is constrained to use the same beam for both diversity branches. Single user transmission modes are described in Table 1, multi-user modes are described in Table 2. It should be noted that the single user/multi-user distinction and the descriptions provided here are with respect to one channel, but can be used for all available channels and that it is possible to use different modes for different channels or users. There may be alternative multiple access technologies.

Those having ordinary skill in this art will readily recognize that all modes may be generalized to the case in which different transmit diversity branches directed at a single user may use different beams, with the addition of per-polarization beam selection and CQI feedback in the uplink. Furthermore, such a person will readily recognize that the single-user modes presented for the downlink in Table 1 may be generalized to uplink transmissions for a UE using the system of the present invention.

The single user modes tend to decrease interference and provide link gain, resulting in improved coverage for the wireless communication system. Multi-user modes do not decrease interference but support more total throughput, which is a capacity improvement.

Referring to Table 1, modes A1, A2, and A3 from Table 1 have been previously discussed in the art in the context of a pure diversity system, that has no directional transmission, for CDMA systems cf Derryberry, R.T. et al, “Transmit Diversity in 3G CDMA Systems”, IEEE Communications, April 2002, pp 68-75). Mode A4 is related to the Per Antenna Rate Control scheme, which has also been described in the art in the context of pure diversity.

The UE provides channel feedback such as channel quality indication (CQI) to the base station, which may be used by the base station in selecting a suitable transmission mode. In many wireless networks, CQI may also enable the base station to execute link control features such as modulation, coding, or power control, and scheduling to multiple users. In the present invention, the UE reports back CQI measurement for both diversity branches using the preferred beam(s) at the serving base station.

The intrinsic low fading correlation resulting from diversity transmissions allows the base station to simply estimate link capacity using one or both transmission streams.

The CQI estimation at the UE is based on pilot measurements, which the UE pre-processes with the known preceding transformation. This leads to a potential issue when pilot transmissions from other base stations in a network are measured, to estimate interference since the other station's pilots are not transformed through any preceding. To avoid undue pilot processing at the UE, the effects of beamforming would only be seen on the wanted signal and not interference from other base stations. The CQI derivation may therefore include a small compensation factor to reduce the estimate of other cell interference to account for the beam gain. This compensation factor can be derived from computer simulation.

TABLE 1
Modes supporting single-user per channelization
resource

| Transmission Mode Option | Implications for UE Receiver |
|---|---|
| A1. Single beam & user w/ | Single antenna UE is possible. |
| Selection Diversity. User | Multi-antenna UE could improve |
| gets polarity with best | performance. UE feeds back |
| channel | beam index + CQI for each |
| | polarity |
| A2. Single beam & user w/ | Single antenna UE is possible. |
| STTD - user stream decomposed | Multi-antenna UE could improve |
| into two substreams which are | performance. UE feeds back beam |
| sent on the two polarities | index and joint CQI covering |
| with, e.g., Alamouti coding | both div. branches |
| A3a. Single beam & user | Single antenna UE is possible. |
| w/ closed loop Tx Diversity | Multi-antenna UE could improve |
| (TxAA). Both diversity | performance. UE feeds back |
| branches transmit the same | beam index + complex channel |
| user stream, with relative | measurements to derive optimal |
| scaling and phase shift | weights and optionally channel |
| determined from UE's DL | quality information depending on |
| channel estimate. | the exact nature of the receiver |
| | design. Additional CQI |
| | information may be fed back if |
| | required to support other |
| | network features such as link |
| | control and scheduling. |
| A3b. Single beam & user w/ | Single antenna UE is possible. |
| transmit polariation | Multi-antenna UE could improve |
| selection. All transmit | performance. UE feeds back beam |
| power is switched onto the | index + one bit to select the |
| polarization with highest | polarization. Additional CQI |
| received power as determined | information may be fed back if |
| from UE's DL channel | required to support other |
| estimate. | network features such as link |
| | control and scheduling. |
| A4. Single beam & user w/ | UE needs minimum of two antennas |
| MIMO. User stream is | to separate two substreams. |
| decomposed into two | Additional UE antennas could |
| substreams which are | improve performance¹. UE feeds |
| independently coded and sent | back beam index + CQI for each |
| on the two polarities | polarity on that beam |

TABLE 2
Modes supporting two or more users per channelization resource

| Transmission Mode Option | Implications for UE Receiver |
|---|---|
| B1a) Single beam, 2 users. | UE needs two antennas to |
| Each user generates a single | separate two user streams. UE |
| stream that is independ-ently | feeds back beam index + CQI for |
| coded and sent on one polarity. | each polarity on that beam |
| B1b) Two beams, 2 users. Each | Single antenna UE is possible |
| user generates a single stream | for case of spatially distinct |
| that is independently coded and | beams. Multi-antenna UE to |
| sent on one polarity. | improve performance. UE feeds |
| | back beam index and CQI for |
| | each polarity. |
| B1c). Two beams, 4 users-2 | UE needs minimum of two |
| users per beam. Each user | antennas for X-pol |
| generates a single stream that | cancellation. Multi-antenna UE |
| is independently coded and sent | to improve performance. UE |
| on one polarity. | feeds back beam index and CQI |
| | for each polarity |
| B2a) Single beam, 2 users. Two | Single antenna UE is possible. |
| user streams are mixed onto | Multi-antenna UE to improve |
| both polarities with STTD | performance. UE feeds back |
| coding. The streams have a | beam index and single joint CQI |
| common block coding and | for both polarities |
| modulation scheme. | |
| B2b) Two beams, 4 users-2 | UE needs minimum of two |
| users per beam. Streams from | antennas to separate streams |
| two users on a given beam are | from 4 users. Multi-antenna UE |
| mixed onto both polarities via | to improve performance. UE |
| STTD coding. | feeds back beam index and |
| | single joint CQI for both |
| | polarities |
| B3a. Two beams, two users, | Double antenna UE needed to |
| with closed loop Tx diversity | separate user data streams. |
| (TxAA). Both polarities | More UE antennas to improve |
| transmit the same stream to one | performance. UE feeds back |
| user on one beam on both | beam index + complex channel |
| diversity branches, with | measurements to derive optimal |
| relative scaling and phase | weights and optionally channel |
| shift determined by UE's | quality information depending |
| channel DL estimate. Same is | on the exact nature of the |
| done for a second user on a | receiver design. Additional |
| different beam. | CQI information may be fed back |
| | if required to support other |
| | network features such as link |
| | control and scheduling. |
| B3b. Two beams, two users, w/ | Double antenna UE needed to |
| transmit polarization | separate user data streams. |
| selection. Feedback from each | More UE antennas to improve |
| user selects one polarization | performance. Each UE feeds |
| for that user; all power for | back beam index + polarization |
| that user is concentrated on | selection index. Additional |
| that user's selected | CQI information may be fed back |
| polarization. | if required to support other |
| | network features such as link |
| | control and scheduling. |
| B4. Two beams, 2 users w/MIMO. | UE needs minimum of two |
| Each user transmission is | antennas to separate two |
| decomposed into two substreams | substreams. More UE antennas to |
| which are independently coded | improve performance. UE feeds |
| and sent on the two polarities | back beam index + CQI for each |
| | polarity on that beam |

It should be noted that in the above tables, performance improvements from additional UE antennas could improve link gain and improve the ability to reject interference.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and

methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

Examples of such types of computers are the spatial grouper 110, scheduler 120, AMCs 130-135, pre-coder matrix 150, 160 and pilot tone mixers 170-173 contained in the pre-coder 100, suitable for implementing or performing the apparatus or methods of the invention.

The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

What is claimed is:

1. A multiple-input multiple-output (MIMO) wireless communications system comprising a transmitter and a receiver,
a. the transmitter comprising:
i. a plurality of transmit antenna elements having a plurality of diversity characteristics for transmitting user data to the receiver;
ii. a directional transmitter for acting on a first set of weight parameters to coherently combine those transmit antenna elements having a first common diversity characteristic into a first set of directional beams having the first diversity characteristic and for acting on a second set of weight parameters to coherently combine those antenna elements having a second common diversity characteristic into a second set of directional beams each having the second diversity characteristic, the first and second sets providing a plurality of independent MIMO channels for transmission of the user data between the transmitter and the receiver; and
iii. a pilot generator associated with each transmit antenna element, for introducing a mutually orthogonal pilot symbol into the user data transmitted by its associated transmit antenna element along each beam in the associated set of directional beams; and
b. the receiver comprising:
i. at least one receive antenna element for receiving the first and second sets of directional beams;
ii. a memory for storing the first and second sets of weight parameters;
iii. a receive processor for determining a preferred beam in the first and second sets of directional beams based on the stored first and second sets of weight parameters; and
iv. a reverse channel signaler for communicating to the transmitter the preferred beam;
wherein the transmitter may transmit the user data intended for the receiver along the preferred beam to the receiver.

2. A MIMO wireless communications system according to claim 1 wherein the transmitter further comprises a controller for receiving and distributing data from the reverse channel signaler.

3. A MIMO wireless communications system according to claim 1 wherein the reverse channel signaler transmits at least one channel quality index.

4. A MIMO wireless communications system according to claim 3 wherein one of the at least one channel quality index reflects the channel quality for the first set of directional beams.

5. A MIMO wireless communications system according to claim 3 wherein one of the at least one channel quality index reflects the channel quality for the second set of directional beams.

6. A MIMO wireless communications system according to claim 3 wherein one of the at least one channel quality index reflects the channel quality for the first and second directional beams.

7. A MIMO wireless communications system according to claim 3 wherein the transmitter further comprises a scheduler for scheduling user data in accordance with the channel quality index communicated by the receiver.

8. A MIMO wireless communications system according to claim 1 wherein the transmitter further comprises a data grouper for associating user data with the preferred beam determined by the receiver.

9. A MIMO wireless communications system according to claim 1 wherein the transmitter further comprises an adaptive modulation coder associated with each beam in the first and second sets of directional beams.

10. A MIMO wireless communications system according to claim 9 wherein the adaptive modulation coder alters the modulation scheme in accordance with at least one of the channel quality indices communicated by the receiver.

11. A MIMO wireless communications system according to claim 9 wherein the adaptive modulation coder alters the coding scheme in accordance with a channel quality index communicated by the receiver.

12. A MIMO wireless communications system according to claim 1 wherein the transmit antenna elements having the first diversity characteristic form a first antenna array and the transmit antenna elements having the second diversity characteristic form a second antenna array.

13. A MIMO wireless communications system according to claim 1 wherein the diversity characteristic is polarization diversity.

14. A MIMO wireless communications system according to claim 13 wherein the transmit antenna elements comprise at least one multiple polar element having a plurality of co-located antenna elements operable from a common antenna aperture.

15. A MIMO wireless communications system according to claim 13 wherein the inter-element spacing of the transmit antenna elements is a fraction of a wavelength at which the system operates.

16. A MIMO wireless communications system according to claim 1 wherein the diversity characteristic is spatial diversity.

17. A MIMO wireless communications system according to claim 1 wherein the first set of weight parameters has three parameters.

18. A MIMO wireless communications system according to claim 1 wherein the second set of weight parameters each have three complex coefficients.

19. A MIMO wireless communications system according to claim 1 wherein the first and second sets of weight parameters each have three complex coefficients.

20. A MIMO wireless communications system according to claim 1 wherein the receiver processor knows the set of preferred beam weights and determines the preferred beam therefrom.

21. A MIMO wireless communications system according to claim 1 wherein the receiver processor detects the received amplitude of the orthogonal pilot symbols and determines the preferred beam therefrom.

22. A MIMO wireless communications system according to claim 1 wherein the receiver processor detects the received phase of the orthogonal pilot symbols and determines the preferred beam therefrom.

23. A MIMO wireless communications system according to claim 1 wherein the receiver processor determines the preferred beam according to the maximum power estimate from each of the beams in one of the sets of directional beams.

24. A MIMO wireless communications system according to claim 1 wherein the receiver processor downloads the set of preferred beam weights from the transmitter and determines the preferred beam therefrom.

25. A MIMO wireless communications system according to claim 1 wherein the transmitter and the receiver are adapted to transmit and receive the data traffic in a plurality of transmission modes.

26. A MIMO wireless communications system according to claim 25, wherein the plurality of transmission modes comprise at least one transmission mode that supports a single user per set of directional beams.

27. A MIMO wireless communications system according to claim 26 wherein the at least one transmission mode is selected from the group consisting of single beam and user with selection diversity, single beam and user with STTD, single beam and user with closed loop transmit diversity (TxAA), single beam and user with transmit polarization selection and single beam and user with MIMO.

28. A MIMO wireless communications system according to claim 25, wherein the plurality of transmission modes comprise at least one transmission mode that supports a plurality of users per set of directional beams.

29. A MIMO wireless communications system according to claim 28, wherein the at least one transmission mode is selected from the group consisting of single beam and two users, two beams and two users, two beams and four users (two users per beam), single beam and two users whose user streams are mixed onto both polarities with STTD coding, two beams and four users (two users per beam whose streams are mixed onto both polarities with STTD coding), two beams and two users with closed loop transmit diversity (TxAA), two beams and two users with transmit polarization selection and two beams and two users with MIMO.

30. A MIMO wireless communications system according to claim 25 wherein the transmitter further comprises a mode processor for dynamically changing the transmission mode to suit propagation channel conditions and user data traffic demands based on feedback received from the receiver.

31. A MIMO wireless communications system according to claim 30 wherein the receiver processor measures a signal required by the mode processor to dynamically select the transmission mode and feeds back the signal to the transmitter.

32. A MIMO wireless communications system according to claim 25 wherein the receiver processor dynamically changes the transmission mode to suit propagation channel conditions and traffic demands, based on feedback received from the transmitter.

33. A MIMO wireless communications system according to claim 25 wherein the transmitter processor measures a signal required by the receiver processor to dynamically select the transmission mode and feeds back the signal to the receiver.

34. A MIMO wireless communications system according to claim 1 wherein the receiver further comprises:
a processor for demodulating received MIMO spatial channels.

35. A transmitter for a multiple-input multiple-output (MIMO) wireless communications system comprising:
a plurality of transmit antenna elements having a plurality of diversity characteristics for transmitting user data to a receiver;
a directional transmitter for acting on a first set of weight parameters to coherently combine those transmit antenna elements having a first common diversity characteristic into a first set of directional beams having the first diversity characteristic and for acting on a second set of weight parameters to coherently combine those antenna elements having a second common diversity characteristic into a second set of directional beams each having the second diversity characteristic, the first and second sets providing a plurality of independent MIMO channels for transmission of the user data between the transmitter and the receiver; and
a pilot generator associated with each transmit antenna element, for introducing a mutually orthogonal pilot symbol into the data transmitted by its associated transmit antenna element along each beam in the associated set of directional beams
whereby the receiver may determine a preferred beam from the received pilot symbols and communicate it to the transmitter for use with the user data intended for the receiver.

36. A receiver for a multiple-input multiple-output (MIMO) wireless communications system comprising:
at least one receive antenna element for receiving, from a transmitter, a first set and a second set of directional beams containing user data coherently combined using sets of weight parameters, each beam further comprising a series of initially orthogonal pilot symbols associated with each antenna element of the transmitter;
a memory for storing the first and second sets of weight parameters;
a receiver processor for determining a preferred beam in the first and second sets of directional beams based on the stored first and second sets of weight parameters; and
a reverse channel signaler for communicating to the transmitter the preferred beam;
whereby the receiver may determine a preferred beam and communicate it to the transmitter wherein the transmitter may transmit the user data intended for the receiver along the preferred beam to the receiver.

37. A receiver according to claim 36 further comprising a process for demodulating received MIMO spatial channels.

38. A method of multiple-input multiple-output (MIMO) wireless communications between a transmitter and a receiver comprising the steps of:
a. the transmitter:
i. acting on a first set of weight parameters to coherently combine transmit antenna elements having a first common diversity characteristic into a first set of directional beams each having the first diversity characteristic;
ii. acting on a second set of weight parameters to coherently combine antenna elements having a second common diversity characteristic into a second set of directional beams each having the second diversity characteristic;
iii. providing the first and second sets of directional beams as a plurality of independent MIMO channels for transmitting user data between the transmitter and the receiver; and
iv. introducing a mutually orthogonal pilot symbol into the user data transmitted by its associated transmit antenna element along each beam in the associated set of directional beams; and
b. the receiver:
i. receiving the first and second sets of directional beams at at least one receive antenna element;
ii. storing the first and second sets of weight parameters;
iii. determining a preferred beam in the first and second sets of directional beams based on the stored first and second sets of weight parameters; and
iv. communicating to the transmitter the preferred beam;
wherein the transmitter may transmit the user data intended for the receiver along the preferred beam or beams to the receiver.

39. A method according to claim 38 wherein the receiver demodulates received MIMO spatial channels.
